(19) United States
(12) Patent Application Publication
(10) Pub. No.: US 2018/0205441 A1
(43) Pub. Date: Jul. 19, 2018

(54) SHORT UPLINK FEEDBACK RELATED METHODS AND APPARATUS

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Simone MERLIN, San Diego, CA (US)

(21) Appl. No.: 15/872,959

(22) Filed: Jan. 16, 2018

Related U.S. Application Data
(60) Provisional application No. 62/447,376, filed on Jan. 17, 2017.

(51) Int. Cl. H04B 7/06; H04W 72/04; H04L 25/02

(52) U.S. Cl. CPC H04B 7/0626; H04W 72/0413; H04L 25/0224; H04W 72/044; H04B 7/0617; H04W 72/042

(57) ABSTRACT

A method, an apparatus, and a computer-readable medium for wireless communication are provided. In one aspect, an apparatus, e.g., an AP, may transmit, to a set of stations, a trigger frame comprising a request for feedback from each station of the set of stations and an indication of a plurality of resources for each station to provide the feedback. The AP may receive, based on the transmitted trigger frame, a feedback in one or more LTFs included in a response from at least one station of the set of stations. In an aspect, the feedback maybe a multibit feedback. The feedback from the at least one station may include at least one of a buffer status report, operating mode information, HE Link Adaptation information, uplink power headroom information, bandwidth query report information, or channel state information.

### CROSS-REFERENCE TO RELATED APPLICATION(S)

This application claims the benefit of U.S. Provisional Application Ser. No. 62/447,376 entitled “SHORT UPLINK FEEDBACK RELATED METHODS AND APPARATUS” filed on Jan. 17, 2017, which is expressly incorporated by reference herein in its entirety.

### BACKGROUND

### Field

The present disclosure relates generally to communication systems, and more particularly, methods and apparatus for short uplink feedbacks from one or more devices.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

In an aspect of the disclosure, a method, a computer-readable medium, and an apparatus are provided. The apparatus (e.g., an access point) for wireless communication, may be configured to transmit, to a set of stations, a trigger frame to solicit short uplink feedbacks, e.g., that may be transmitted in a PHY header of a response data unit, in accordance with some example embodiments. The trigger frame may include a request for feedback, e.g., feedback of a given type, from each station of the set of stations, and may indicate a plurality of resources for each station to provide the feedback. The AP may receive, based on the transmitted trigger frame, a feedback within one or more long training fields (LTFs) included in a response from at least one station of the set of stations. In an aspect, the feedback maybe a multibit feedback.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an example wireless communication system in which aspects of the present disclosure may be employed.

FIG. 2 illustrates a trigger frame and a feedback response transmitted on a single allocated resource.

FIG. 3 illustrates an example trigger frame and an example feedback response transmitted on a plurality of allocated resources.

FIG. 4 illustrates the structure of a trigger frame with some of the information fields in the trigger frame being shown in an expanded form.

FIG. 5 illustrates the structure of an example user information field that may be used in a trigger frame in certain configurations.

FIG. 6 illustrates an example structure of an Aggregate Control (A-Control) field.

FIG. 7 is a diagram illustrating an example trigger frame and feedback responses from two stations on allocated resources.

FIG. 8 illustrates an example sequence showing a multi-user downlink data block and an example response block in which feedbacks from multiple users may be provided, in accordance with an example configuration.

FIG. 9 illustrates an example sequence of a trigger frame, an example response block in which feedbacks and uplink data from multiple users may be provided, and a block acknowledgement frame.

FIG. 10 illustrates an example of uplink multi-user (UL MU) channel sounding, in accordance with certain aspects described herein.

FIG. 11 is a flowchart of an example method of wireless communication.

FIG. 12 illustrates a functional block diagram of an example wireless communication device that may be used in the wireless communication system of FIG. 1.

FIG. 13 illustrates an example showing communication between an access point and a station where the station may transmit feedback to the access point in accordance with an aspect.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

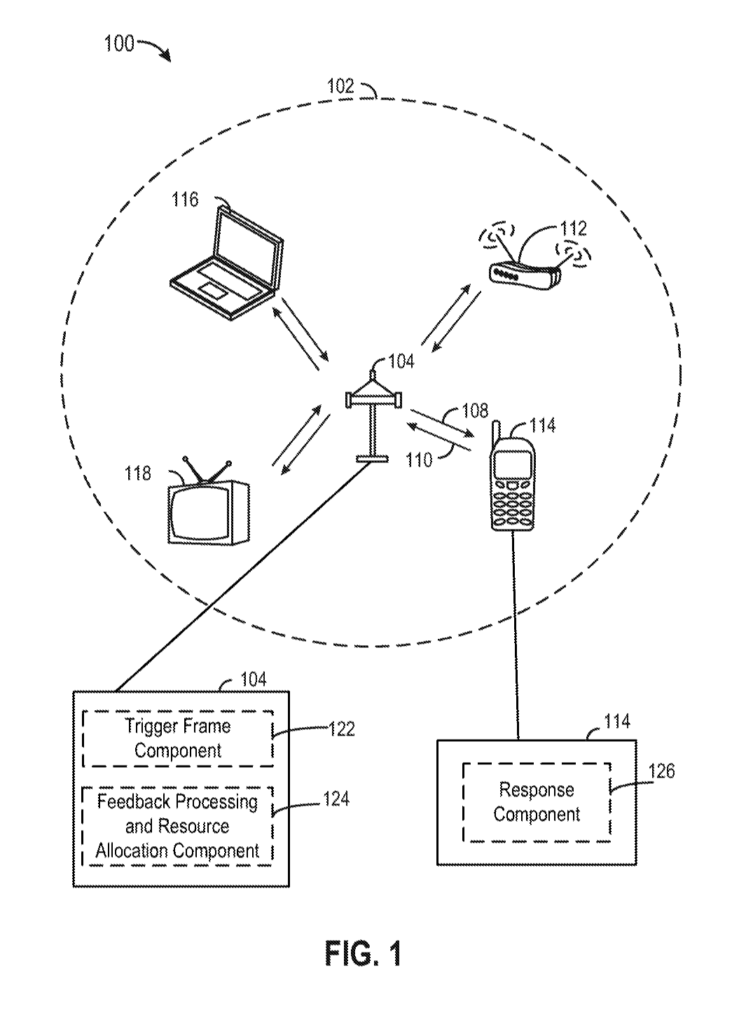

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions in accordance with the methods described herein. For example, the AP 104 may include a trigger frame component 122 for generating a trigger frame to solicit feedback from the stations and to indicate resources for providing such feedback in accordance with various aspects described herein. The AP 104 may further include a resource allocation component 124 to perform procedures related to allocating resources for uplink transmission based on feedback information. The resource allocation component 124 may be configured to receive from each station a response over an uplink resource based on the transmitted trigger frame. The response may include the feedback.

In another aspect, the STA 114 may include one or more components for performing various functions. For example, the STA 114 may include a response component 126 that may perform procedures related to providing a response, e.g., short feedback, data acknowledgment, and/or uplink data, on resource units allocated for transmission of such response. For example, in an aspect the response component 126 may provide a short feedback based on a trigger frame including a request for feedback from the AP 104.

In wireless networks, an AP may transmit a control frame (e.g., a trigger frame) to STAs, e.g., to request feedback from the stations and to indicate a set of resources (e.g., allocations) assigned to the STAs for uplink transmissions, e.g., such as short feedback, data acknowledgments, and/or uplink data.

An NDP feedback is a mechanism for an AP (e.g., AP 104 which may be a high efficiency (HE) AP) to collect short feedbacks from multiple HE STAs in an efficient manner. The short feedbacks (e.g., resource requests) may be sent without data payloads in response to a trigger frame. For example, in an aspect, an AP (e.g., AP 104) may send a trigger frame to solicit NDP feedback response from a plurality of STAs. The STA from which feedback is solicited may be identified by a range of scheduled associations identifiers (AIDs) in the trigger frame. The NDP feedback response from a HE STA may be included in a HE physical layer protocol data unit (PPDU) without data payloads. A STA may use the information carried in the trigger frame to determine if the STA is scheduled (e.g., allocated resources to send NDP feedback), and if so, to derive one or more parameters for the transmission of the response.

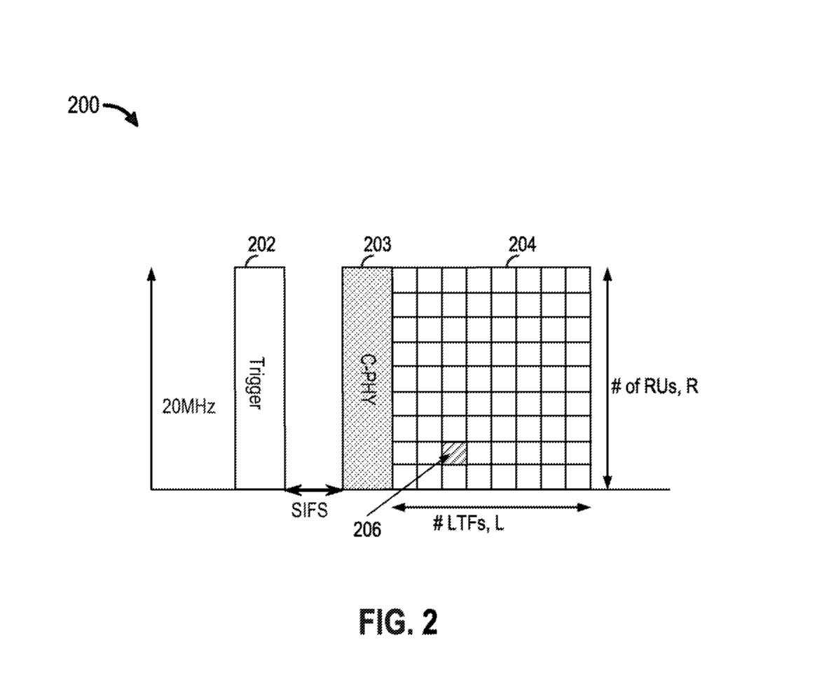

FIG. 2 is a drawing 200 illustrating a trigger frame 202 and a feedback response from a station transmitted on a single allocated resource. Referring to drawing 200, an AP may send a trigger frame 202, with a particular query to one or more stations. The query may be request for a feedback. For example, the query maybe a specific request to stations (STAs) to ask whether they want a resource, e.g., an uplink transmission resource. In certain aspects, a station may respond to the query by “lighting up” (e.g., by putting energy on an allocated resource in a resource block 204 or transmitting a signal on the allocated resource in the resource block 204 with a transmit power above a threshold) the <L, R> allocation 206 assigned to the station if the response to the query is YES. The response transmitted on the resource (e.g., the <L, R> allocation 206) may serve as a feedback to the query from the particular station that was assigned the <L, R> allocation 206. In various example configurations, the feedback transmitted on the <L, R> allocation 206 is included within a long training field (LTF), e.g., a high efficiency (HE) long training field of a PPDU of future 802.11 standards (e.g., future 802.11ax standard). For example, the resource block 204 may illustrate a resource matrix, e.g., where each <L, R> in the matrix indicates a resource. The resources corresponding to the block 204 may be assigned to different STAs from which feedback may be solicited. The different STAs may transmit their feedbacks (e.g., in the LTF) on their respective <L, R> allocations. The resource block 204 may correspond to a 20 MHz frequency band (in terms of frequency) a number of LTFs (in terms of time).

In some configurations, the block 204 is preceded by a common physical layer (C-PHY) preamble portion 203. The <L, R> allocation to the STA may be indicated in the trigger frame 202 and if the STA wishes to respond, the STA may put energy on the allocated tones or a subset of the allocated tones corresponding to the allocated <L, R>. In FIG. 2 example, one <L, R> may be allocated to one STA. Each square in the resource block 204 may represent an <L, R> allocation, and in one example each <L, R> may include 26 OFDM tones (e.g., 26 OFDM tones within a 13 micro second LTF over approximately a 2 MHz band). However, if there is no need for the resources, the station does not respond. In many such systems, one resource, e.g., one <L, R> allocation, is allocated to one STA. However, in FIG. 2 example, the information that may be transmitted by a STA may be restricted to 1 bit. Furthermore, the information from the STA communicated via the assigned <L, R> allocation does not include actual data payload. Thus, the feedbacks transmitted on the resources in the resource block 204 may include NDP and not data payload. However, since each STA is allowed transmission of a single bit, no protection may be needed for checking detection reliability. As will be discussed, in accordance with various features described herein, enabling transmission of multiple bit feedback from each of the stations may allow a variety of information to be communicated to the AP. Furthermore, using the techniques and features described herein, the overall spectral efficiency is improved.

In some systems, an AP can poll up to 72 STAs in 20 MHz, 144 in 40 MHz, 296 in 80 MHz, and 592 in 160 MHz. While polling up to 72 STAs may be good in some scenarios, it would be desirable to be able to identify the use cases where polling up to 72 STAs may be simply not enough. Further in many such systems, a STA can only send one bit of information per poll, independent of the resource availability. This results in poor spectral efficiency (starting from 1 bit per 88 us (exchange duration) ˜11 kbps). Furthermore, currently there is limited flexibility in selection of the stations that can be polled, e.g., different types of devices may not be polled in the same control frame and rather. Moreover, backwards incompatibility also exists, which further limits what devices may be polled in the same frame, e.g., trigger frame. For example, in current systems Wave 1 devices cannot be listed in the same trigger frame as Wave 2 devices. This may be particularly important if more than 1 bit can be signaled in a Trigger-based (TB) PPDU. By having the flexible design in accordance with various features described herein, a variety of different types of devices may be polled in the same trigger frames, e.g., by utilizing a range of AIDs and/or using other techniques described herein.

In accordance with an aspect of the proposed methods, a new control frame, e.g., trigger frame, addresses many of these challenges. In accordance with some features, increased flexibility on what stations can be polled is achieved and backwards compatibility may be maintained. In some configurations, the example trigger frame includes a new trigger type that indicates what type of feedback is requested and/or what the request is, and the trigger frame provides a range of associations identifiers (AIDs) that maps them to the <L, R>, thus providing greater flexibility in selecting different types of devices that can be polled. In accordance with an aspect, in the proposed flexible feedback mechanism, multiple bit sequences per station may be enabled. In other words, each polled station may be allowed to transmit (e.g., as a feedback in a feedback response PPDU) not just a single bit but rather multiple bits in response to the trigger frame.

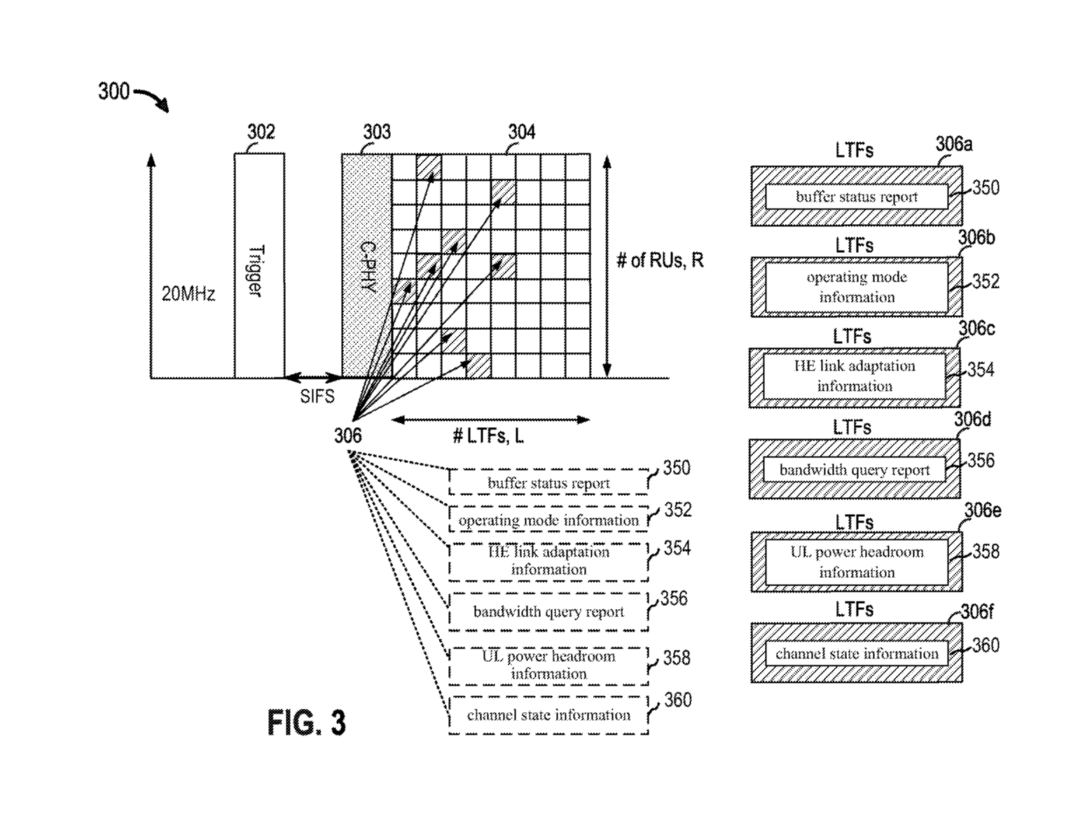

In accordance with the features of various configurations described herein, improved spectral efficiency may be achieved. FIG. 3 is a drawing 300 illustrating an example trigger frame 302 and an example resource block 304 preceded by a C-PHY block 303. The inter frame space between a PPDU that includes the trigger frame 302 and the start of the C-PHY block (e.g., C-PHY preamble 303) is a short inter frame space (SIFS). The trigger frame 302 may solicit feedback (also sometimes referred to as NDP feedback) from a set of stations (e.g., one or multiple STAs) and may allocate resources for feedback response transmission, e.g., by providing an indication of the resources corresponding to the illustrated resource block 304 for providing the feedback. The resource block 304 shows the resources (e.g., <L, R> allocations) one or more of which may be allocated to a station for providing feedback. For example, an AP (e.g., AP 104) may provide transmission schedules/resource allocation to STAs using the trigger frame 302 which may indicate which STAs may transmit their feedbacks and which resources the STAs may use. In other words, the trigger frame may indicate a set of resources, e.g., a set of <L, R> allocations, assigned to STAs for transmission of their feedback. In some other configurations, the indication of resources to be used by STAs for feedback may be implicit. For example, based on implicit signaling from the AP or preconfigured information, a STA may know what <L, R> allocations of the resource block 304 it may use to transmit feedback if the trigger frame indicates that the STA has been polled (e.g., queried), e.g., if the STA's association identifier (AID) is indicated in the trigger frame.

In accordance with one aspect, multiple <L, R> allocations may correspond to a single STA, e.g., with each STA being allocated multiple resources (e.g., multiple <L, R> allocations per STA) and not just one <L, R> as compared to FIG. 2 example. In various configurations, a STA that wishes to send feedback may include the feedback information in the LTFs of its response PPDU transmitted on the assigned <L, R> allocations. Thus, in various configurations, the allocated resources for feedback transmission correspond to LTFs and resource units (RUs) in a resource block. Enabling multiple <L, R> allocations per STA may allow a STA to communicate various types of information (not restricted to a single bit), e.g., by putting power on a subset and/or full set of the allocated resources. For example, in the illustrated example of FIG. 3, a station (e.g., STA 114) that has been assigned 8 resources (e.g., 8 <L, R> allocations) may selectively concentrate power on the 8 <L, R> allocations (indicated by 306) to communicate the feedback (e.g., as a codeword). The AP may check which locations in the matrix (e.g., <L, R> resource matrix shown in block 304) have energy, determine which STAs responded and decode the codeword conveying the communicated information.

In accordance with some features, in a PHY layer approach, more than one bit may be conveyed by a station in one <L, R> allocation. In some embodiments, methods to increase bits per second (bps) in one <L, R> may be used. For example, each <L, R> allocation may include 26 tones and more than one bit may be communicated using the multiple tones corresponding to the allocated <L, R> using appropriate modulation and coding techniques. One <L, R> allocation (also referred to as resource) may be considered as a container of information, e.g., a signal-C (SIG-C), or Service field. The container can expand over multiple Ls, or multiple Rs (e.g., across multiple symbols corresponding to LTFs and multiple resource units (RUs) in a corresponding frequency band). Thus, in this manner the spectral efficiency may be improved and more numbers of bits may be packed for communication per <L, R> if desired.

In a MAC approach, multiple <L, R> allocations to the same station may be enabled in some configurations. In accordance with the features of some embodiments, linear increase of information bits per STA is adopted (e.g., consider a set of <L,R> as a container). Thus, if multiple resources, e.g., <L, R>, are allocated to a station, and even if one bit is communicated using one <L, R>, still a multi-bit transmission can be performed by each of the STAs because of the multiple <L, R> allocations. In some configurations, the resource block 304 may correspond to a multi-user transmission, where the various resources (<L, R>s) are allocated to multiple STAs. For example, in a 20 MHz band, we may have, e.g., 72 <L, R> allocations available in the resource block 304 where multi station transmission may occur, e.g., in response to a trigger frame 302. In one such example, 9 STAs may be scheduled to transmit 8 bits each, e.g., with each of the 9 STAs being assigned 8 <L, R> allocations in the resource block 304 and assuming 1 bit transmission per <L, R> allocation. For example, in one example embodiment, the entire first row (with eight <L, R> units) in the block 304 may have been assigned to a first station. The first station may use the allocations to communicate 8 bits of information (since the first row has 8 <L, R>s and assuming one bit is communicated using one <L, R> allocation) in various ways by using different coding schemes. In such a case, the block 304 may be shared by, e.g., 9 STAs (e.g., with each STA being allocated a different row of <L, R>s in the matrix of block 304). In such a case, if the first station wants to communicate, e.g., a “1”, then the first station may put energy on tones corresponding to one <L, R> (one square in the matrix), e.g., by concentrating power on the right most square of row in the matrix assuming there is an understanding between the AP and the first station on interpreting the least significant bit and the most significant bit (‘00000001’). And if the first station wants to communicate an “8”, then the first station may utilize transmit (‘00001000’) by putting energy on the fourth block from the right on the top row.

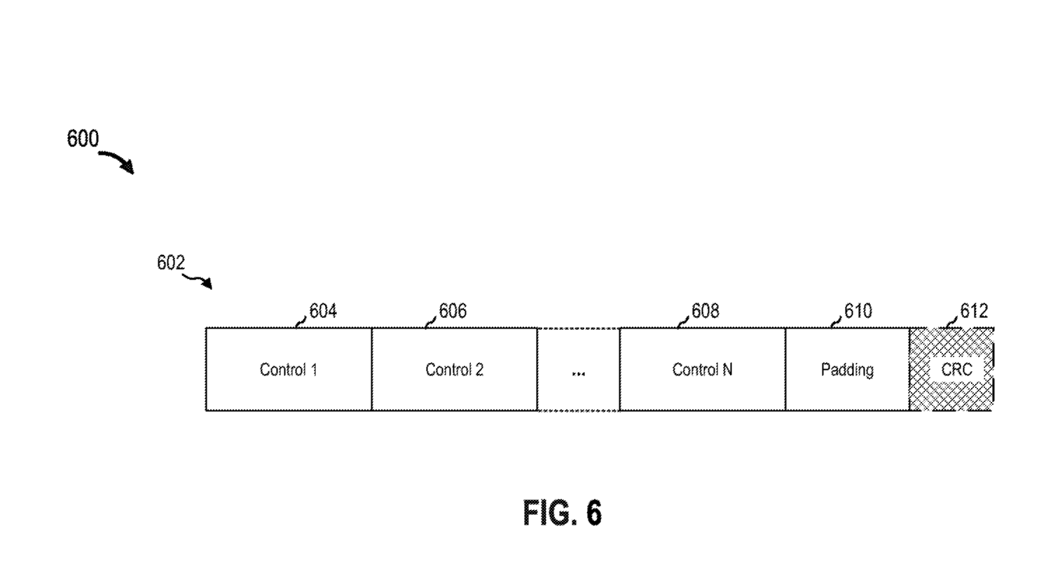

In some configurations, the example resource block 304 may be used to send Aggregated control (A-Control) field discussed in greater detail below with respect to FIG. 6. In other words, the information communicated by a STA via the <L, R> allocations may include information corresponding to A-Control field. As such, the A-Control field may carry buffer status report (BSR), operating mode information (OMI), high efficiency (HE) Link Adaptation, bandwidth query report, UL power headroom information, channel state information, and other such information. In some embodiments, the container (e.g., the information bits) may be protected by a cyclic redundancy check (CRC) for increased robustness.

For example, with reference to FIG. 3, a station (e.g., STA 114) may use the multiple assigned resources 306 (e.g., <L, R> allocations) to communicate one or more of a buffer status report (BSR) 350, operating mode information (OMI) 352, HE link adaptation information 354, bandwidth query report 356, UL power headroom information 358, channel state information 360, and/or other such information or a combination thereof as a feedback. In one example, a station may have a buffer status report for transmission to an AP (e.g., AP 104). In such an example, the station may use a set of allocations 306a (from the assigned <L, R> allocations 306) to transmit BSR 350 as a feedback in the LTFs. In another example, a station may use a set of allocations 306b to transmit OMI 352 as a feedback in the LTFs. In another example, a station may use a set of allocations 306c to transmit HE link adaptation information 354 as a feedback. In yet another example, a station may use a set of allocations 306d for transmitting bandwidth query report 356 as a feedback in the LTFs. In yet another example, a station may use a set of allocations 306e for transmitting UL power headroom information 358 as a feedback in the LTFs. In still another example, a station may use a set of allocations 306f for transmitting UL power headroom information 360 as a feedback in the LTFs.

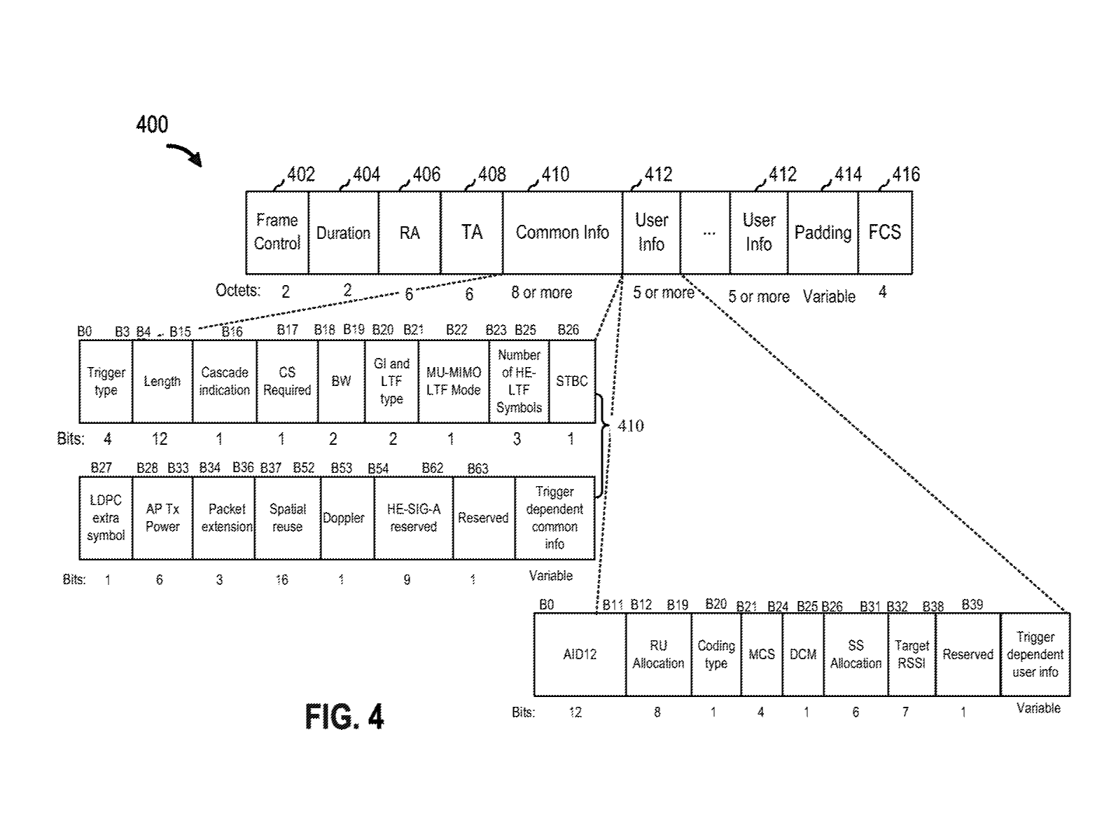

FIG. 4 is a drawing illustrating the structure/format of an example trigger frame 400 that may be used to request feedback in certain aspects described herein. In the example of FIG. 4, the trigger frame 400 is illustrated with some of the fields (such as the User Info field and the Common Info field) of the trigger frame 400 being shown in expanded form. The trigger frame 400 may be an 802.11ax compliant trigger frame and/or a trigger frame of future 802.11 standards. As discussed supra, in certain aspects, a trigger frame may be used to solicit feedback from stations and allocate resources for feedback response transmission, e.g., in a HE PPDU. The trigger frame may also carry other information that allows the responding stations to send the feedback. The trigger frame may include a frame control field 402, a duration field 404, a receiver address (RA) field (or multiple RA fields) 406, a transmit address (TA) field 408, a common information field 410, one or more user info fields 412, a padding 414, and a frame check sequence (FCS) 416. The RA field 406 may identify the address of the recipient STA. If the trigger frame has one recipient STA, then the RA field 406 may be the MAC address of the STA. For example, the RA field 406 is set to the individual address of the STA if the trigger frame has only one user information field including 12 LSBs of the AID of the STA in the AID12 field. If the trigger frame has multiple recipient STAs, then the RA field 406 may include a broadcast address, e.g., if the trigger frame has more than one user information field including. The TA field 408 may include the address of the device transmitting the trigger frame (e.g., AP 104).

The common information field 410 may include a number of subfields as shown in the expanded version. The common information field 410 may include trigger type information (e.g., bits B0 to B3) indicating the type of trigger frame and/or what is being requested (e.g., as a feedback) by an access point sending the trigger frame. Different values (e.g., 0, 1, 2 etc.) in the trigger type field may indicate different types of the trigger frame. The length subfield may indicate the value of the L-SIG length field of the feedback response PPDU that may be a response to the trigger frame 400. The cascade indication subfield may be set to 1 if a subsequent trigger frame is scheduled for transmission, otherwise the cascade indication subfield is set to 0. The CS required subfield may be set to 1 or 0 to indicate whether the STAs identified in the user information fields are required to use energy detection (ED) to sense the medium and to consider the medium state and the network allocation vector (NAV) in determining whether or not to respond. The BW subfield may indicates the bandwidth in the HE-Signal-A (HE-SIG-A) of the feedback response PPDU. The GI And LTF type subfield indicates the guard interval (GI) and LTF type of the feedback response PPDU. If the Doppler subfield of the common info field is 0, then the number of HE-LTF symbols subfield indicates the number of HE-LTF symbols present in the feedback response PPDU that is the response to the trigger frame minus 1. If the Doppler subfield is 1, then B23-B24 of the number of HE-LTF symbols subfield indicates the number of HE-LTF symbols present in the response PPDU that is the response to the trigger frame, and B25 of the subfield indicates midamble periodicity in the same response PPDU. The space-time block coding (STBC) subfield of indicates the status of STBC encoding of the feedback response PPDU that is a response to the trigger frame, e.g., it is set to 1 if STBC encoding is used and set to 0 otherwise. Similarly, the remaining subfields (e.g., LDPC extra symbol segment subfield, AP transmit (Tx) power subfield, packet extension subfield, spatial reuse subfield, Doppler subfield, HE-SIG-A reserved subfield, trigger dependent common information subfield) provide information and/or parameters that allow the responding station(s) to send the feedback response.

An example mapping of one or more user information fields 412 of the example trigger frame 400 may be as follows. The AID12 subfield in the user information field 412 includes bits B0 to B11, where B11 may be reserved. The AID12 subfield may indicate the AID of the station for which the given user information field 412 is intended and the RU allocation subfield of the user info field 412 may indicate the RU to be used for providing the response feedback by the STA identified by the AID12 subfield. In an aspect of the proposed methods, different AIDs may be indicated by the respective AID12 subfields of different user information fields 412, e.g., by utilizing more than one user information field of the trigger frame 400. In some configurations, as many user information fields 412 may be used in the trigger frame 400 as many stations are desired to be polled. The resource allocation to the various stations being polled may be indicated in a variety of ways. For example, in some configurations the AID12 subfield may identify the AID of the station for which the user information field in intended and the RU allocation may indicate a set of resources allocated to the station having the AID indicated in the AID field. If a plurality of user information fields are utilized for a plurality of different stations, then the AID of each such user information field may indicate the AID of the station from which feedback is solicited and the corresponding RU allocation may indicate the set of allocated resources. In another configuration, when multiple stations are polled and multiple user information fields are used, a station being polled may be explicitly identified in a user information field but the resource allocation may be indirect. For example, the RU allocation subfield of the user information field 412 may indicate an RU offset. The offset may indicate where the <L, R> allocations for a given station are relative to a start and may indicate to a STA the boundary of the resource allocations. In one such example of a two user information field trigger frame, if the RU offset indicated in a RU allocation subfield of a first user information field (e.g., intended for STA 1) is, e.g., 1, and the next RU offset indicated in a RU allocation subfield in the second user information field (e.g., intended for STA 2) is, e.g., 16, then STA 1 may interpret that resources 1 to 15 (e.g., in the resource block 304) are allocated to the first station and STA 2 may determine that its allocations starts from resource 16 till the last resource. In some other configurations, the indication of resources to be used by STAs for transmitting their feedback response PPDUs may be implicit. For example, there may be a known mapping of AIDs (indicated in user information fields) to resources that is known to STAs. For example, STA 1 having AID if polled (e.g., if AID is identified in a first user info field) will use resources 1 to 8 for providing feedback, a STA 2 having AID2 if polled (e.g., if AID2 is identified in a second user info field) will use resources 9 to 16.

The user information field 412 further includes a coding type subfield that indicates the code type of the feedback response PPDU that may be transmitted in response to the trigger frame. The MCS subfield indicates the MCS of the feedback response PPDU that may be transmitted in response to the trigger frame. The dual carrier modulation (DCM) subfield indicates dual carrier modulation of the feedback response PPDU that is the response to the trigger frame. The DCM subfield may be set to 1 to indicate that DCM is used and 0 to indicate that DCM is not used. The SS allocation/random access RU Information subfield may indicate the spatial streams of the feedback response PPDU, or may indicate the random access RU information. The target RSSI subfield indicates the target receive signal power averaged over the AP's (e.g., AP 104) antenna connectors for the feedback response PPDU. The trigger dependent user info subfield may be optionally present based on the value of the trigger type field.

The Padding field 414 is optionally present in a trigger frame 400 to extend the frame length to give the recipient STAs enough time to prepare a response SIFS after the frame is received, and may have a variable length. The FCS field 416 of the trigger frame may include a frame check sequence.

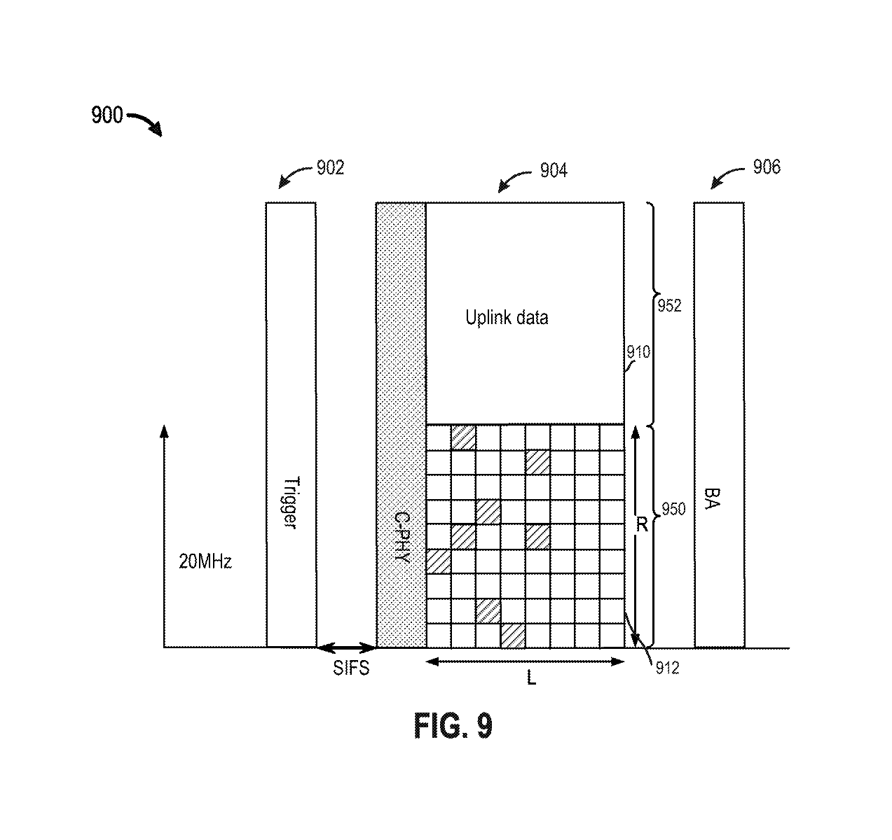

In accordance with an aspect, a trigger frame format such as the one illustrated in drawing 400 may be used in some configurations to poll stations, e.g., for short uplink feedback (also referred to as NDP feedback because the feedback is without data payload). As discussed above, the trigger type of the common information field of the trigger frame may indicate what the AP is requesting (e.g., the type of requested feedback). While a basic trigger frame such as trigger frame 400 illustrated in FIG. 4 may be used in some configurations to poll stations, in some other configurations a buffer status report poll (BSRP) trigger frame variant may be used to solicit feedback. The station(s) may respond by transmitting a feedback (e.g., on allocated <L, R>s such as shown in block 304) to indicate that the station has data e.g., a resource request. In some other configurations, a Beamforming Report Poll (BRP) variant of the trigger frame 400 may be used for UL MU sounding (e.g., for channel sounding). In such a configuration, the UL duration (e.g., indicated by the length subfield of the common information field) may implicitly indicate (to the stations to which BRP variant trigger frame is transmitted) that only NDP feedbacks are allowed from the stations. This is discussed in more detail in connection with FIG. 9. In accordance with an aspect, with such a configuration of the trigger frame as discussed above, there may be no need for a separate feedback type field as the trigger frame variant (BRP variant) implicitly indicates the feedback type, e.g., because the indicated uplink duration allows only NDP feedback. Furthermore, if multiple control information is allowed as feedback, e.g., on the <L, R> allocations, then the stations may need not know requested feedback type.

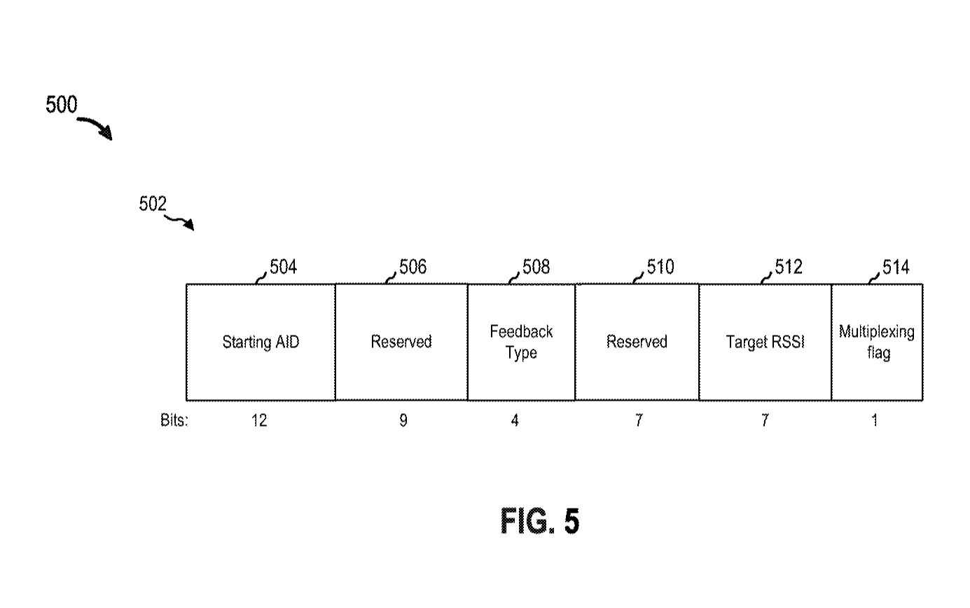

FIG. 5 is a diagram 500 illustrating the structure of a variant of user information field 502 that may be used in the example trigger frame 400 as an alternative to the user information field 412. In the example user information field 502, the starting AID subfield 504 may indicate the AID of a station for the user information field 502 is intended, or the start AID subfield 504 may indicate a first AID of a range of AIDs that are scheduled to respond to the trigger frame (in which user info field 502 is included). In one example configuration, when an AID range is to be indicated in the user information field 502, the bit B11 may be set to 1 to indicate to the stations (that may receive the trigger frame with user information field 502) that starting AID indicates an AID range. Thus, using the user information field 502, the stations from which feedback is requested may be indicated by a range of AIDs. The feedback type subfield 508 indicates the type of feedback requested from the stations. The total number of stations (NsTA) that are scheduled to respond to the trigger frame is determined based on N_{STA}=18×2^{BW}× (Multiplexing flag), where BW is the value indicated in the BW subfield of the trigger frame 400 and multiplexing flag is the value indicated in the multiplexing flag subfield 514. The multiplexing flag subfield 514 indicates the number of STAs that are multiplexed with P-matrix codes on the same set of tones in the same RU, and is encoded as the number of STAs minus 1. In an aspect, the resource allocation to STAs for providing feedback may be indicated using the reserved subfields 506 and/or 510 of the user information field 502.

FIG. 6 is a drawing 600 illustrating an example Aggregate Control (A-Control) field 602. The A-Control field 602 may be defined as a universal carrier of a variety of control information needed for different features, e.g., 802.11ax features. The A-Control field 602 is flexible and can be dynamically added to a PPDU with minimal overhead. Utilizing an A-Control field to provide control information may provide many benefits. For example, it may reduce MAC overhead and simplify design as it eliminates the need of aggregating multiple control frames. The A-Control field 602 may include a plurality of HE control subfields 604, 606, . . . , 608, e.g., each with 4 or more bits, for communicating control information, and a padding portion 610. Each HE control subfield carries control information for different HE features. In some configurations, the container (e.g., the information bits) may be protected by a cyclic redundancy check (CRC) for increased robustness. Thus, for increased robustness, CRC 612 may be added in some configurations. The A-Control field 602 may be considered as a generic container that may carry, in some configurations, operating mode information, HE link adaptation, buffer status report, UL power headroom information, bandwidth query report, channel state information etc., e.g., in the control subfields 604, 606, . . . , 608. As discussed above, in accordance with an aspect of some configurations, multiple <L, R> allocations per station may be enabled and assigned in a trigger frame to stations thereby allowing one or more stations to provide control information corresponding to the A-Control field 602 using the assigned resources, e.g., such as the <L, R> allocations 306, as feedback in response to the trigger frame 302.

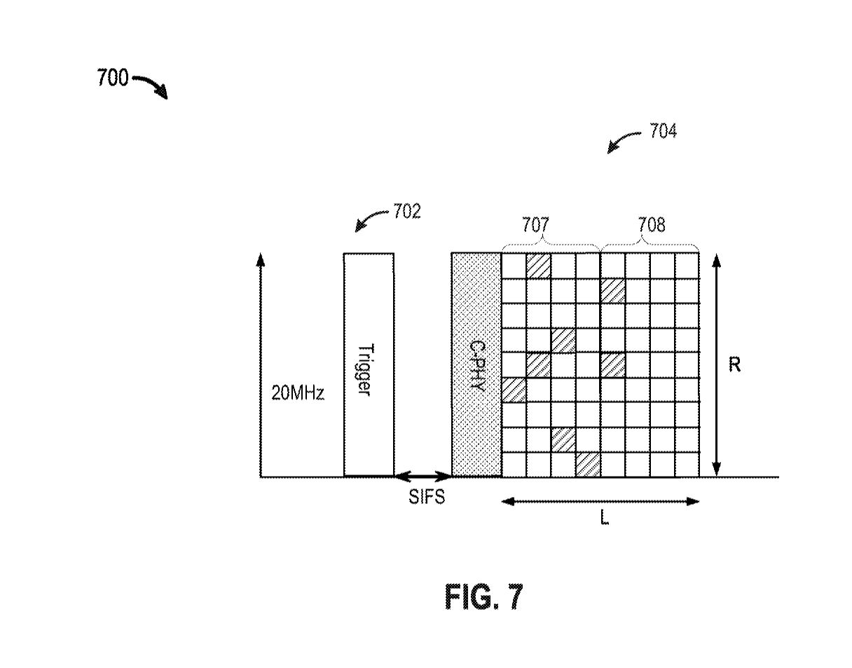

FIG. 7 is a diagram 700 illustrating an example showing a trigger frame 702 and feedback responses from two stations on allocated resources shown in an example resource block 704. Diagram 700 also illustrates an example logical partitioning of resources e.g., in a 20 MHz resource block 704, between the two stations that are polled in the trigger frame 702 for feedback in the example. In the illustrated example, the trigger frame 702 may include two user information fields that are intended for two different stations. As discussed earlier, in some configurations, by utilizing the respective AID12 fields corresponding to different user information fields, different AIDs may be indicated, and thus using two user information fields, two AIDs corresponding to two STAs may be indicated in the same trigger frame 702. For example, AID of a first user information field may indicate a first, while an AID12 field of a second user information field of the trigger frame 702 may indicate a second AID. The first AID may correspond to a first station (e.g., STA 1) and the second AID may correspond to a second station (e.g., STA 2), where STA 1 and STA 2 are the stations being polled and being allocated resources (e.g., <L, R> allocations) for feedback in the example.

In the illustrated example, an AP may indicate (e.g., in the first user information field of the trigger frame 702) that a first set of resources (e.g., 706 of the resource block 704) are allocated to STA 1 and a second set of resources (e.g., 708 of the resource block 704) are allocated to STA 2. The resource allocation to the stations may be indicated in various ways as discussed supra. For example, STA 1 and STA 2 receiving the trigger frame may determine, based on the respective AID12 subfields and RU allocations subfields of the two user information fields in the trigger frame 702, which resources have been assigned to each station for providing corresponding feedback. In an aspect, the allocated resources may be sufficient for STA 1 and STA 2 to transmit their feedbacks in respective response PPDUs but without data payload. For example, the UL duration (e.g., indicated in the length subfield of common information in the trigger frame 702) may indicate that only NDP feedback can be sent. In other words, the UL duration may indicate that there may be no more room except for the LTFs in a feedback response PPDU. Thus, in accordance with the methods described herein, the feedbacks from the stations STA 1 and STA 2 may be transmitted in the LTFs of their respective response PPDUs. For example, the feedbacks may be included in the PHY headers of the respective response PPDUs.

In the example illustrated in FIG. 7, STA 1 transmits its feedback response PPDU on the first set of resources (706) to STA 1, e.g., on the 36 <L, R> allocations. For example, STA 1 may transmit power above a threshold on the six resources shown with a diagonal pattern filling indicating transmission of “1” on these resources while not putting power on the remaining of its <L, R> allocations thereby indicating a transmission of “0” on these resources. Such a transmission communicates a codeword corresponding to the feedback information from STA 1. Similarly, STA 2 may transmit its feedback response PPDU on the second set of resources (708) allocated to STA 2. For example, STA 2 may transmit power above a threshold on the two resources in the second set of resources (708) shown with a diagonal pattern filling indicating transmission of “1” and no energy on the remaining of its <L, R> allocations thereby indicating transmission of “0”. Thus, the stations corresponding to the identified AIDs, may provide their feedback on their corresponding <L, R> allocations.

In another example, one resource (e.g., one <L, R> allocation in the block 704) may be allocated per station to request feedback from a large number of stations. For example, in such a case the trigger frame 702 may utilize one or more user information fields (e.g., such as user information field 502) where a range if AIDs is indicated and each station having an AID that corresponds to the indicated AID range may be allocated one resource in the resource block 704. In one such example, two user information fields may be used to indicate two AID ranges (e.g., AID range 1 and AID range 2), and the stations associated with the two AID ranges may each be assigned one <L, R> allocation to provide a short feedback. For example, the resources in the set 706 of the block 704 may be used by stations 1-36, e.g., associated with AID range 1, to provide feedback on a corresponding <L, R> allocation (e.g., with each station being allocated one <L, R> in this example) while the resources in the set 708 may be used by another group of stations, e.g., stations 100-136 associated with AID range 2, to provide feedback on a corresponding <L, R> allocation. Thus, in some example configurations, a single resource may be allocated to a large number of stations to collect feedback. While a single resource per station may be allocated in some examples, a station providing feedback may either transmit a single bit feedback on its assigned resource, or a station may encode multiple bits on the assigned resource using appropriate modulation and coding technique thereby providing a multi-bit feedback. As discussed, more than one AID range may be covered (as discussed above) and not just a single AID range. In various configurations, the stations provide their feedback in the LTFs of their response PPDUs transmitted on the <L, R> allocations.

In some embodiments, the UL duration (e.g., indicated in a length subfield of common info field) indicated in the trigger frame 702 may indicate that only NDP feedback can be sent.

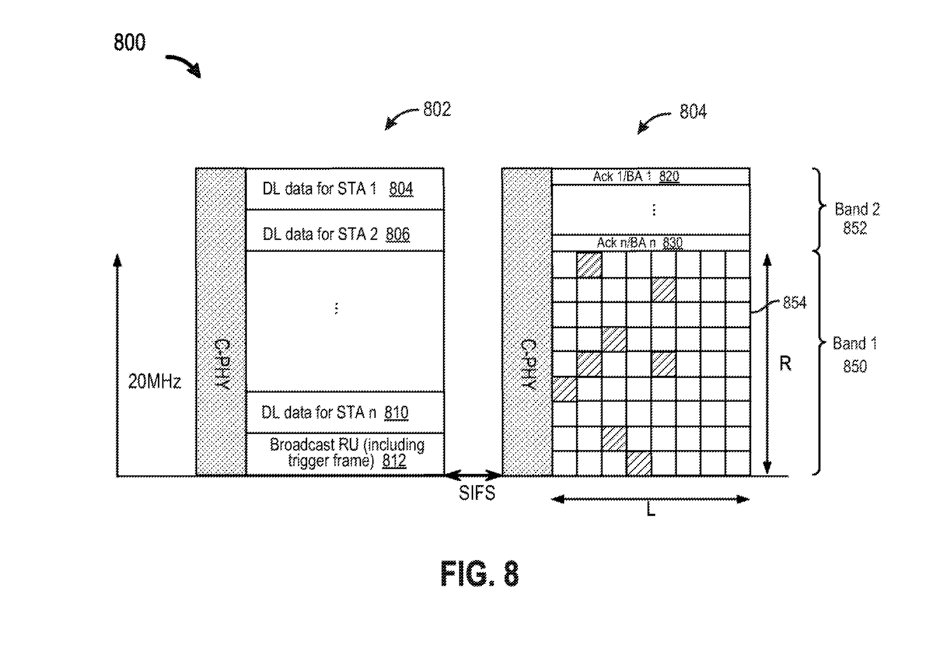

FIG. 8 is a diagram 800 illustrating an example sequence showing a multi-user downlink data block 802 and an example response block 804 in which feedbacks from multiple users may be provided, in accordance with an example configuration. In the illustrated example, the first block 802 may correspond to a MU DL PPDU 802 with downlink data corresponding to multiple stations sent by an AP (e.g., AP 104) in the DL data portion 808. The AP may transmit DL Data to multiple stations, e.g., in multiple different resource units corresponding to the DL PPDU 802 as illustrated. For example, the MU DL PPDU 802 may include DL data for a first station (STA 1) as shown by 804, DL data for a second station (STA 2) as shown by 806, . . . , and DL data for a nth (STA n) as shown by 810. The downlink data for each station (e.g., STA 1 through STA n) is addressed specifically to the station for which the downlink data is intended. The AP may also indicate with each DL data transmission that an acknowledgement (ACK) or block acknowledgement (BA) is requested for the DL data from the receiving station in a given frequency band.

Additionally, the MU DL PPDU 802 includes a broadcast RU 812 that may include broadcast information. In one example configuration, the AP may include a trigger frame in the broadcast RU 812 to solicit short feedbacks from another set of stations (e.g., different from the stations STA 1 to STA n to which DL data is transmitted). For example, the trigger frame included in the broadcast RU 812 may include multiple user information fields indicating AIDs and resource allocations for the other stations to provide their feedback. The short feedbacks from the other stations may be solicited in a different frequency band (e.g., first band 850) than the frequency band (e.g., second band 852) in which ACKs/BAs are solicited from STA 1 through STA n. Thus, via the trigger frame, while the AP may send downlink data to one set of stations and solicit ACK/BAs from these stations for the downlink data in one band, the AP may also solicit short feedbacks from another different set of stations in another band.

The stations (e.g., STA 1 through STA n) to which DL data is transmitted in block 802 may transmit their ACKs/BAs (e.g., ACK1/BA1 820, . . . , ACK n/BA n 830) in a different band (e.g., illustrated second band 852) than a band (e.g., illustrated first band 850) in which short UL feedbacks are transmitted by other stations from which feedback was solicited in the trigger frame. For example, STA 1 through STA n may transmit their respective ACKs/BAs in the second frequency band 852 in response to the downlink data received by STA 1 through STA n, while one or more other stations from which UL feedback was solicited in the trigger frame may transmit their respective feedbacks on the assigned <L, R> allocations in the portion 854 of the block 804 that corresponds to the first frequency band 850. In some configurations, the UL duration indicated in the trigger frame may allow for more than NDP feedback, but not for hosting MAC protocol data units (MPDU5). For example, in some configurations, the lower bound for length of the data field is 20 octets (e.g., for an ACK feedback). For some other frames however, the length may be higher, e.g., 36 octets for QoS Null. The feedback, provided by the other stations from which the AP solicits feedback in the trigger frame may not be limited to one bit only, but rather sending multiple bit feedback is possible because each station may be assigned multiple resources (e.g., <L, R> allocations). Thus, multiple <L, R> allocations per station may be enabled in some configurations so that stations can transmit more than a single bit feedback in the portion 854 of the block 804. Such a flexible design and dynamic resource allocation may enable stations to send A-Control field (e.g., the control information of the type discussed with regard to A-control field 602) in their feedbacks.

FIG. 9 is a diagram 900 illustrating an example sequence of a trigger frame 902, an example response block 902 in which feedbacks and uplink data from multiple users may be provided, and a block acknowledgement frame 906. In accordance with some features, an AP (e.g., AP 104) may solicit (e.g., by requesting in the trigger frame 902) short feedbacks from a first set of stations (e.g., one or more stations) in a first band 950, e.g., corresponding to portion 912 of the response block 904. For example, the trigger frame 902 may include one or more user information fields indicating AIDs and resource allocations for the one or more stations of the first set to provide their uplink feedback (e.g., NDP feedback). For example, the short feedbacks from the first set of stations may be solicited in a first frequency band 950 (e.g., a 20 MHz frequency band). In addition, the AP may solicit UL data from a different (e.g., second) set of stations by including a request for uplink data from the second set of stations. For example, the trigger frame 902 may further include additional one or more user information fields indicating the second set of stations from which uplink data is solicited and resource allocation for the second set of stations to transmit respective uplink data. The trigger frame 902 may indicate (e.g., in one or more user info fields) that the uplink data is to be provided by the identified second set of stations on resources corresponding to a second frequency band 952 (e.g., a higher 20 MHz frequency band than first band). In some configurations, high transmit rates in a very limited amount of time (e.g., 4×) may be achieved for transmission of the uplink data. The BA frame 906 may include ACK/block ACK from the AP in response to the UL data transmitted by the second set of stations and received by the AP.

Thus, in certain aspects, via such a trigger frame 902, the AP may solicit short feedbacks from one set of stations in one band and solicit uplink data from another set of stations in a different band. In some configurations, the information provided by the first set of stations may not be limited to one bit only. For example, the first set of stations from which short feedbacks are requested may be assigned multiple resources (e.g., multiple <L, R> allocations per STA). Thus, the one or more stations may transmit their feedback on corresponding multiple allocated resources allowing for transmission of multi-bit information. Alternatively, even if a single resource (e.g., single <L, R> allocation) is allocated to the stations for uplink feedback, the stations may use appropriate modulation and coding techniques to transmit more multibit feedback on the allocated resource.

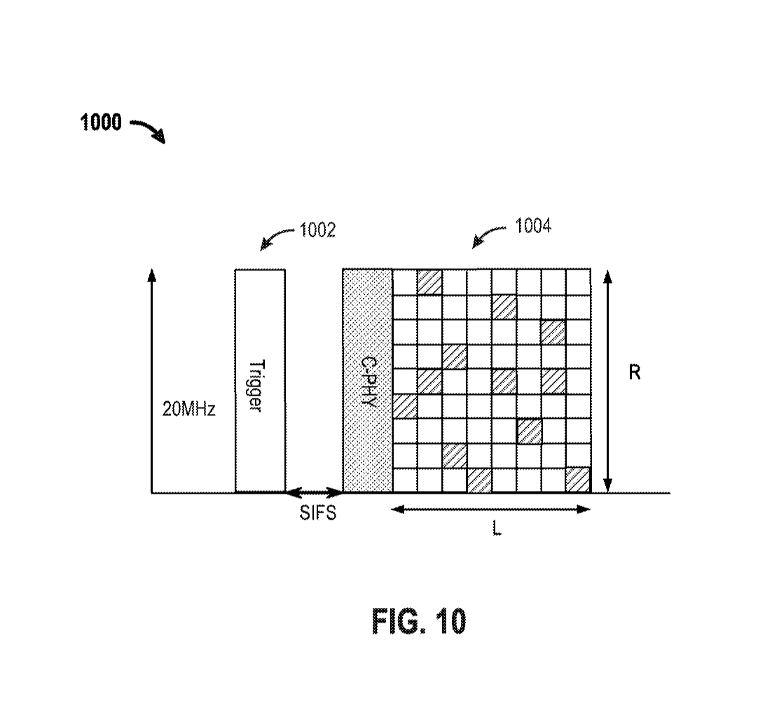

FIG. 10 is a diagram 1000 illustrating an example of uplink multi-user (UL MU) channel sounding, in accordance with certain aspects described herein. In an aspect, an AP (e.g., AP 104) may sound multiple different channels from multiple stations in one frequency band, e.g., 20 MHz frequency band. In an example aspect, the AP may transmit a trigger frame 1002 to solicit sounding feedback (e.g., channel state information) from stations, e.g., for channel estimation purposes. This may be achieved, in some configurations, using a BRP variant trigger frame 1002. For example, in one case the AP may send the BRP variant trigger frame 1002 requesting a number of stations to send their compressed beamforming feedback (CBF) in response to the trigger frame 1002. The trigger frame 1002 may indicate the resource allocations for the stations from the CBF is requested. However, resource allocation to each station indicated in the BRP variant trigger frame 1002 may not be enough for the station to transmit the CBF. In an aspect, in response to the trigger frame 1002, each polled station may transmit one or more LTFs in its feedback response PPDU on the allocated resources. For example, multiple polled stations may transmit their feedback on respective allocated resources in the block 1004 as illustrated.

The AP may receive the feedbacks (e.g., LTFs) from different stations on different resources that may correspond to different channels, and perform channel estimation for such channels, e.g., by computing signal to noise ratio (SNR) for each channel based on the feedback received on resources corresponding to the channel.

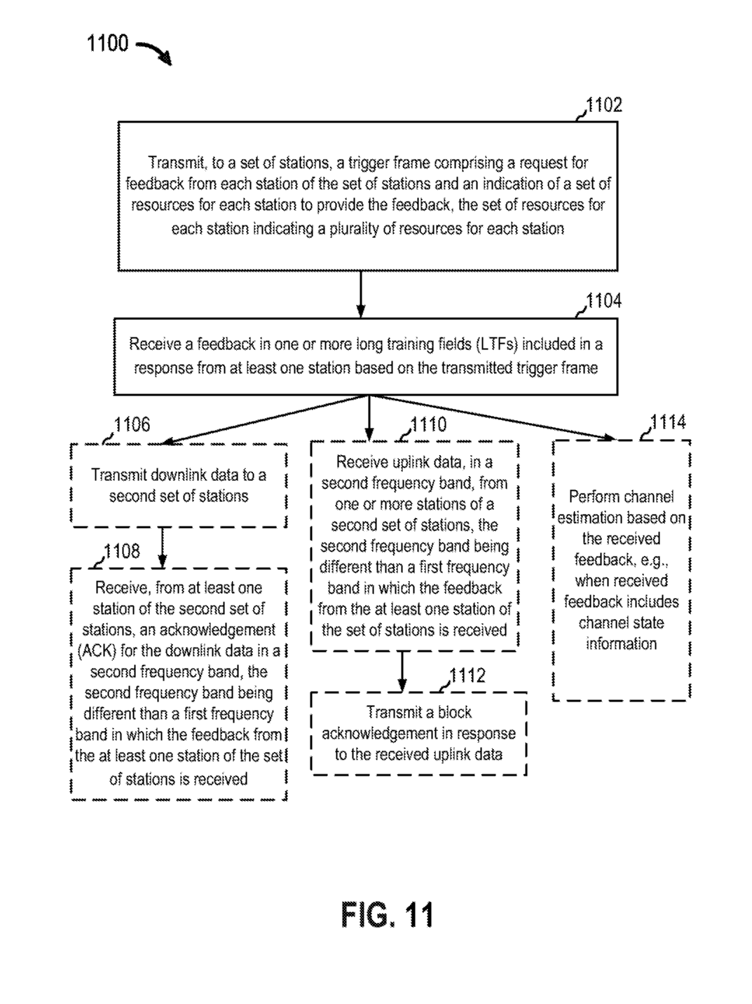

FIG. 11 is a flowchart of an example method 1100 of wireless communication. The method 1100 may be performed using an apparatus (e.g., the AP 104 or any other device described herein).

At block 1102, the apparatus may transmit, to a set of stations, a trigger frame comprising a request for feedback from each station of the set of stations. The trigger frame may further include an indication of a plurality of resources for each station to provide the feedback. For example, as discussed in connection with FIGS. 3-10, an AP may transmit a trigger frame (e.g., having a format such as trigger frame 400) to solicit feedback (e.g., short uplink feedback) from one or more stations, and in some configurations each station may be allocated a plurality of resources (e.g., <L, R> allocations illustrated in various preceding figures) for transmitting feedback. For example, referring to FIG. 3, a station may be allocated 8 resources for transmitting its feedback. In one aspect, the allocation of resources to a given station may be dynamic, e.g., based on a type of feedback being requested. For example, the trigger frame may indicate more resources (e.g., relative to some other stations being polled) being allocated to a station if the type of feedback solicited from the given station requires a relatively greater number of resources. In one aspect, the resources allocated to a station for providing feedback may be sufficient for transmitting one or more long training fields (LTFs) in a PPDU, but may not be enough to transmit data payload. In some configurations, the trigger frame further indicates a type of feedback requested by the apparatus transmitting the trigger frame. In some configurations, the type of requested feedback may be explicitly indicated, e.g., by information in a field of the trigger frame. In some other configurations, the type of requested feedback may be implicitly indicated. For example, in one configuration, the trigger frame includes a common information field indicating an uplink duration (e.g., length subfield), and the indicated uplink duration may implicitly indicate that a null data packet (NDP) feedback may be transmitted in response. In some configurations, the request for feedback is a request for NDP feedback.

In some configurations, the trigger frame may be broadcast to a multiple stations. In some configurations, the stations from which feedback is requested are indicated in one or more user information fields of the trigger frame. In some configurations, there may be a user information field corresponding to each station from which feedback is solicited. In one example, the trigger frame includes a plurality of user information fields including a first user information field and a second user information field and the set of stations to which the trigger frame is transmitted includes a first station and a second station. In this example, the first user information field may indicate a first association identifier (AID) identifying the first station and the second user information field further may indicate a second AID identifying the second station. In such an example, the first user information field may further include an indication of a first set of resources for the first station for providing a first feedback, and the second user information field may include an indication of a second a second set of resources for the second station for providing a second feedback.

At block 1104, the apparatus may receive feedback in one or more LTFs included in a response from at least one station of the set of stations. As discussed earlier, the request for feedback may be a request for a short uplink feedback and the resources allocated to the at least one station may be sufficient to send a feedback in one or more LTFs of a response message (e.g., response PPDU, also sometimes referred to herein as feedback response PPDU). Thus, the apparatus (e.g., AP 104) may receive the feedback in one or more LTFs of the response PPDU from the at least one station. For example, in some configurations, the feedback may be included in a PHY header of the response from the at least one station.

In some configurations, the feedback from the at least one station is a multi-bit feedback. In some configurations, the feedback from the at least one station may include at least one of a buffer status report (BSR), operating mode information (OMI), high efficiency (HE) Link Adaptation information, uplink power headroom information, bandwidth query report, or channel state information. Thus, as discussed earlier, in some configurations, A-Control field may be provided as the feedback by stations in response to the trigger frame.

In one configuration, the trigger frame may be included in a broadcast resource unit of a multi-user downlink (MU DL) PPDU, and the MU DL PPDU may further include downlink data for a second set of stations. For example, referring to FIG. 8, the trigger frame may be transmitted in the broadcast RU 812 of the MU DL PPDU 802 that also includes downlink data for a second set of stations (e.g., STA 1 to STA n) which is different from the set of stations from which feedback is solicited in the trigger frame. In such an example case, the apparatus may transmit the downlink data to the second set of stations as indicated at block 1106. In this example case, the feedback from one or more stations that are polled may be received in a first frequency band. For example, with reference to FIG. 8, the feedback from the at least one station may be received in frequency band 850. Further, in such an example, at block 1108, the apparatus may receive, from at least one station of the second set of stations (e.g., to which downlink data is transmitted), an acknowledgement (ACK) for the downlink data in a second frequency band, e.g., band 852.

In one example configuration, the trigger frame may further comprise a request for uplink data from a second set of stations, where the second set of stations is different from the set of stations from which feedback is requested. For example, referring to FIG. 9, the trigger frame 902 may include the request for feedback from the set of stations, and a request for uplink data from a second set of stations. In such an example case, the feedback from the at least one station of the set of stations may be received in a first frequency band, e.g., band 950. In such an example configuration, at block 1110, the apparatus may receive uplink data, in a second frequency band, from one or more stations of the second set of stations, where the second frequency band is different than the first frequency band and includes a higher frequency range than the first frequency band For example, referring to FIG. 9, the feedback from one or more stations may be received in the first frequency band 950 and the uplink data may be received in the second frequency band 952. In some such example configurations, at block 1112, the apparatus may transmit a block acknowledgement to acknowledge the received uplink data.

In one example, the trigger frame requesting feedback may be a BRP variant trigger frame. For example, the apparatus (e.g., AP 104) may use a BRP variant trigger frame to sound different channels from multiple stations of the set of stations and collect feedback for channel estimation. For example, referring to FIG. 10, the trigger frame 1002 may be a BRP variant trigger frame transmitted to multiple stations for channel sounding. The multiple stations may send channel state information in their feedbacks (e.g., illustrated in block 1004 of FIG. 10). In such an example, the feedback from the at least one station may include at least channel state information. In such an example, at block 1114, the apparatus (e.g., AP 104) may perform channel estimation based on the received feedback. For example, based on the received feedback, the AP may compute an SNR to estimate the channel condition.

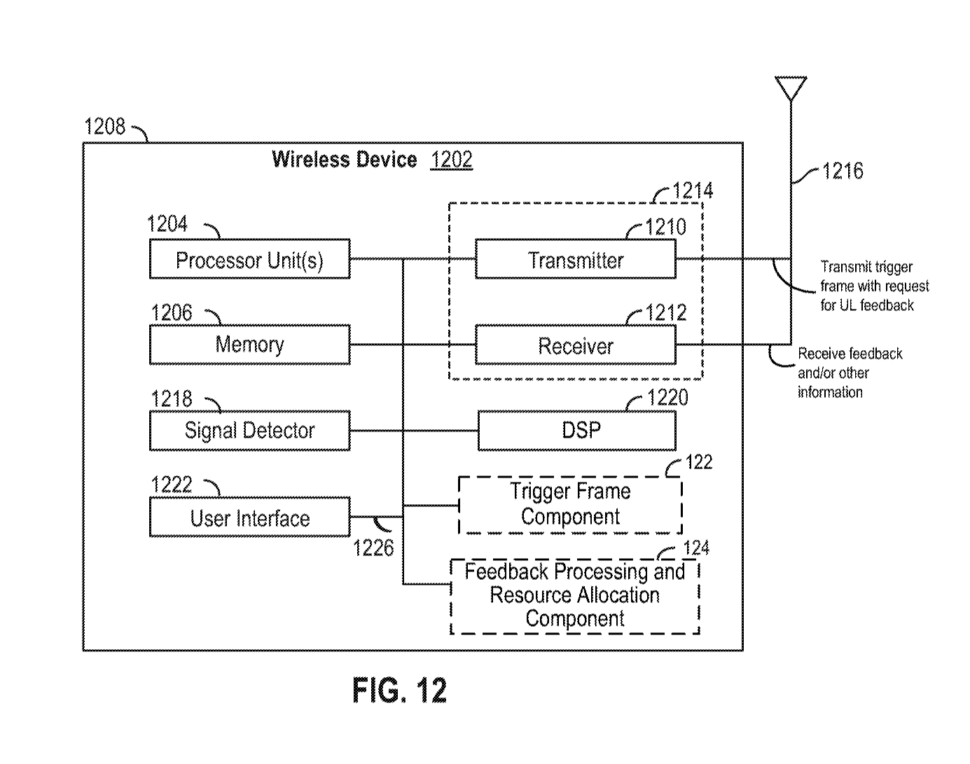

FIG. 12 shows an example functional block diagram of a wireless device 1202 that may be employed within the wireless communication system 100 of FIG. 1. The wireless device 1202 is an example of a device that may be configured to implement the various methods described herein. For example, the wireless device 1202 may comprise an AP (e.g., the AP 104).

The wireless device 1202 may include a processor 1204 which controls operation of the wireless device 1202. The processor 1204 may also be referred to as a central processing unit (CPU). Memory 1206, which may include both read-only memory (ROM) and random access memory (RAM), may provide instructions and data to the processor 1204. A portion of the memory 1206 may also include non-volatile random access memory (NVRAM). The processor 1204 typically performs logical and arithmetic operations based on program instructions stored within the memory 1206. The instructions in the memory 1206 may be executable (by the processor 1204, for example) to implement the methods described herein.

The processor 1204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1202 may also include a housing 1208, and the wireless device 1202 may include a transmitter 1210 and/or a receiver 1212 to allow transmission and reception of data between the wireless device 1202 and a remote device. The transmitter 1210 and the receiver 1212 may be combined into a transceiver 1214. An antenna 1216 may be attached to the housing 1208 and electrically coupled to the transceiver 1214. The wireless device 1202 may also include multiple transmitters, multiple receivers, multiple transceivers, and/or multiple antennas.

The wireless device 1202 may also include a signal detector 1218 that may be used to detect and quantify the level of signals received by the transceiver 1214 or the receiver 1212. The signal detector 1218 may detect such signals as total energy, energy per subcarrier per symbol, power spectral density, and other signals. The wireless device 1202 may also include a DSP 1220 for use in processing signals. The DSP 1220 may be configured to generate a packet for transmission. In some aspects, the packet may comprise a physical layer convergence procedure (PLCP) data unit (PPDU).

The wireless device 1202 may further comprise a user interface 1222 in some aspects. The user interface 1222 may comprise a keypad, a microphone, a speaker, and/or a display. The user interface 1222 may include any element or component that conveys information to a user of the wireless device 1202 and/or receives input from the user.

When the wireless device 1202 is implemented as an AP (e.g., the AP 104), the wireless device 1202 may also comprise a trigger frame component 122 and a feedback processing and resource allocation component 124. The trigger frame component 122 may be configured to generate the various types of trigger frames described earlier for transmission to one or more stations. For example, the trigger frame component 122 may be configured to generate a trigger frame comprising a request for feedback from a set of stations and an indication of a plurality of resources for each station of the set of stations to provide the feedback. The generated trigger frame may be provided to the transmitter 1210 for transmission to the set of stations. Thus, in some configurations, the transmitter 1210 alone, in coordination with and/or under the control of trigger frame component 122, may transmit a trigger frame comprising a request for feedback from a set of stations and an indication of a plurality of resources for each station of the set of stations to provide the feedback.

In some configurations, the receiver 1212 alone, in coordination with, and/or under the control of the feedback processing and resource allocation component 124, may be configured to receive, based on the transmitted trigger frame, a feedback in one or more long training fields (LTFs) included in a response from at least one station of the set of stations. The feedback may be included in a PHY header of a message (e.g., PPDU) without a data payload. The feedback processing and resource allocation component 124 may be configured to process received feedbacks from stations and perform various operations based on the received feedback. For example, if a feedback indicates that the station needs uplink transmission resources, then component 124 may allocate resources for uplink transmission based on the feedback. In some configurations, the feedback from the at least one station may include channel state information and the feedback processing and resource allocation component 124 may perform (alone or in combination with other components) channel estimation based on the received feedback. The resource allocation component 124 may be configured to receive from each station a response over an uplink resource based on the transmitted trigger frame. The response may include the feedback. The resource allocation component 124 may be configured to transmit, to a set of stations, a trigger frame of the type discussed above to one or more stations. The trigger frame may include a request for feedback from each station.

In some configurations where the wireless device 1202 is implemented as an AP, the signal detector 1218 alone, in combination with, or under the control of the feedback processing component 124, may perform channel estimation based on a received feedback from a station in accordance with the certain features of the methods described herein. For example, channel estimation may be performed based on a received feedback, e.g., as discussed in connection with FIG. 10.

In one configuration, the trigger frame is included in a broadcast resource unit of a MU DL PPDU. In one such configuration, the MU DL PPDU further includes downlink data for a second set of stations that are different from the set of stations to which the trigger frame is transmitted to solicit feedbacks, e.g., as discussed in connection with FIG. 8. In such a configuration, the wireless device 1202 may transmit (e.g., via the transmitter 1210) the downlink data to the second set of stations. In one such configuration, the feedback is received from the at least one station in a first frequency band. In addition, the wireless device 1202 may further receive (e.g., via the receiver 1212) from at least one station of the second set of stations, an acknowledgement (ACK) for the downlink data in a second frequency band, where the second frequency band is different than the first frequency band.

In one configuration, in addition to the request for feedback from the set of stations, the transmitted trigger frame further comprises a request for uplink data from a second set of stations (different from the set of stations). In one such configuration, the feedback is received from the at least one station in a first frequency band. Furthermore, the wireless device 1202 may also receive (e.g., via the receiver 1212) uplink data, in a second frequency band, from one or more stations of the second set of stations. In such configurations, the second frequency band is different than the first frequency band and includes a higher frequencies than the first frequency band.

In some other configurations, the wireless device 1202 may be implemented as a station, e.g., a HE STA (e.g., STA 114). In such a configuration, the wireless device 1202 may comprise a response component, e.g., the response component 126 shown in FIG. 1. The response component 126 may perform procedures related to providing a response, e.g., a short feedback of the type described herein, data acknowledgment, and/or uplink data, on resources allocated to the station for transmission of such a response. For example, in an aspect the response component 126 may receive a trigger frame including a request for feedback and an indication of resources allocated for transmission of the response from the AP 104. The response component 126 may determine which LTFs to use for transmitting the feedback based on the trigger frame, e.g., based on how many resources are allocated, type of feedback that is allowed in response to trigger frame, uplink duration indicated in the trigger frame etc. The response component 126 may be configured to transmit the feedback in one or more LTFs in a response PPDU on the allocated resources.

The various components of the wireless device 1202 may be coupled together by a bus system 1226. The bus system 1226 may include a data bus, for example, as well as a power bus, a control signal bus, and a status signal bus in addition to the data bus. Components of the wireless device 1202 may be coupled together or accept or provide inputs to each other using some other mechanism.

Although a number of separate components are illustrated in FIG. 12, one or more of the components may be combined or commonly implemented. For example, the processor 1204 may be used to implement not only the functionality described above with respect to the processor 1204, but also to implement the functionality described above with respect to the signal detector 1218, the DSP 1220, the user interface 1222, and/or the resource allocation component 1224. Further, each of the components illustrated in FIG. 12 may be implemented using a plurality of separate elements.

In one configuration, the wireless communication device 1202 may comprise means for means for transmitting, to a set of stations, a trigger frame comprising a request for feedback from each station of the set of stations and an indication of a plurality of resources for each station to provide the feedback. The wireless communication device 1202 may further comprise means for receiving, based on the transmitted trigger frame, a feedback in one or more LTFs included in a response from at least one station of the set of stations.

In some configurations, the means for transmitting is further configured to transmit downlink data to a second set of stations which may be different from the set of stations from which feedback is requested. In one such configuration, the feedback is received from the at least one station in a first frequency band, and the means for receiving is further configured to receive, from at least one station of the second set of stations, an ACK for the downlink data in a second frequency band, the second frequency band being different than the first frequency band.

In some configurations, the transmitted trigger frame may further comprise a request for uplink data from a second set of stations. In some such configurations, the feedback is received from the at least one station in a first frequency band, and the means for receiving is further configured to receive uplink data in a second frequency band from one or more stations of the second set of stations, the second frequency band being different than the first frequency band and including a higher frequency range than the first frequency band. In some other configurations, the feedback received from one or more stations of the set of stations, in response to the trigger frame requesting feedback, includes channel state information. In some such configurations, the wireless communication device 1202 may further comprise means for performing channel estimation based on the received feedback.

Moreover, means for performing the various functions described herein may include the processor/processing unit(s) 1204, the transmitter 1210, the receiver 1212, the signal detector 1218, the trigger frame component 122, feedback processing and resource allocation component 124, and/or one or more other components described with respect to FIGS. 1 and 12.

While in the various aspects discussed above, the feedback information from a station has been described as being included in one or more LTFs of a PHY header of a response message (e.g., response PPDU), it should be appreciated that many variations are possible and the feedback information may be included in other fields of the PHY header instead of being included in the LTFs. For example, in some configurations, the feedback information may be included in, e.g., SIG-B field, or SIG-C field, or the service field of the PHY header of the response message.

In an aspect, an AP may transmit, to a set of stations, a trigger frame comprising a request for feedback from each station of the set of stations and an indication of a plurality of resources for each station to provide the feedback. In response, at least one station may transmit a feedback in one or more fields of a PHY header of a PPDU. Thus, in such a case, based on the transmitted trigger frame the AP may receive the feedback in one or more fields of a PHY header of a PPDU. For example, in one configuration, in response to a received trigger frame a station may transmit the feedback in one or more LTFs of a response PPDU as discussed above. In another example, the station may transmit the feedback in a SIG-B field of a PHY header of a response PPDU. In yet another example, the station may transmit the feedback in a SIG-C field of a PHY header of a response PPDU. In yet another example, the station may transmit the feedback in a service field of a PHY header of a response PPDU. In one example, the station the feedback may be included in the PHY header such that a portion of the feedback may be in one field of the PHY header (e.g., in one or more LTFs) while another portion may be included in a different field (e.g., SIG-B field, or SIG-C field, or the service field) of the PHY header.

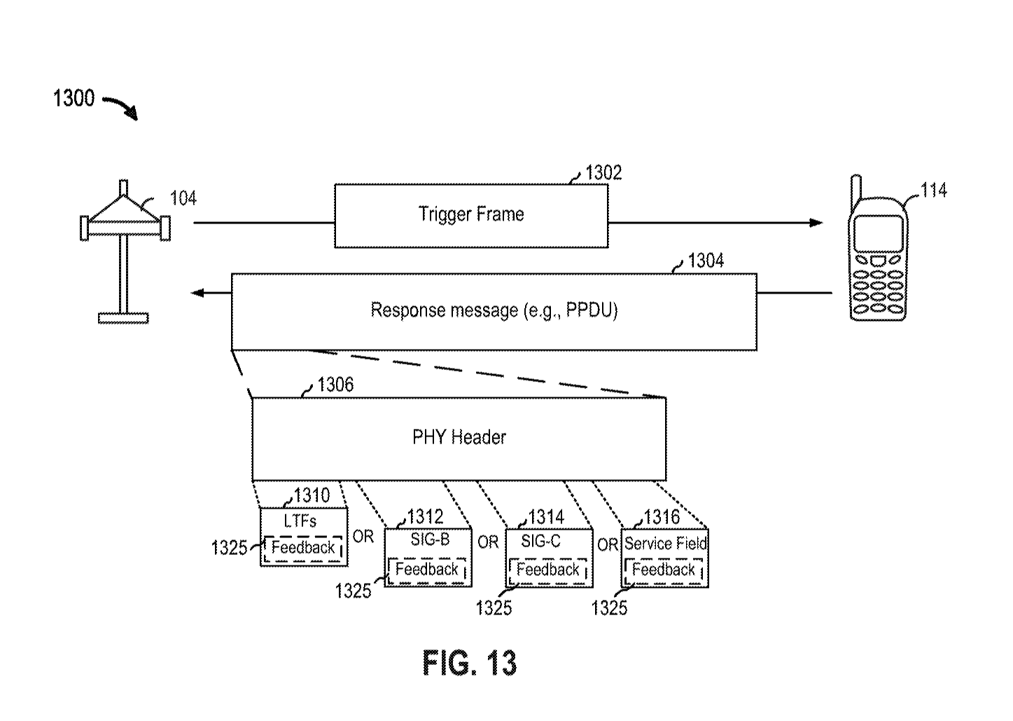

Consider one example with reference to FIG. 13 that illustrates a diagram 1300 showing communication between an access point (e.g., AP 104) and a station (e.g., STA 114). The AP 104 may transmit a trigger frame 1302 which may be received by the STA 114. The trigger frame 1302 may comprise a request for feedback from STA 114 and an indication of a plurality of resources for STA 114 to provide the feedback. In response to the trigger frame 1302 and based on the assigned resources in the trigger frame 1302, the STA 114 may transmit a response message 1304, e.g., a response PPDU, to the AP 104. In accordance with various aspects discussed supra, the STA 114 may transmit a feedback 1325 in one or more fields of a PHY header 1306 of the response PPDU 1304. For example, the feedback 1325 may be included in one or more LTFs 1310 of the PHY header 1306. In other example cases, the feedback 1325 may be included in other fields of the PHY header 1306 instead of being included in the LTFs 1310. For example, in one configuration, the STA 114 may include the feedback 1325 in, e.g., a SIG-B field 1312 of the PHY header 1306. In another example, the feedback 1325 may be included in, e.g., a SIG-C field 1314 of the PHY header 1306. In another example, the feedback 1325 may be included in a service field 1316 of the PHY header 1306. As discussed supra, the feedback from the station may include, e.g., short feedbacks such as ACK/NACK, resource request etc., as well as other types of feedbacks such as a buffer status report, operating mode information, HE link adaptation information, uplink power headroom information, bandwidth query report information, or channel state information, and other such information.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication of an access point, comprising:
transmitting, to a set of stations, a trigger frame comprising a request for feedback from each station of the set of stations and an indication of a plurality of resources for each station to provide the feedback; and
receiving, based on the transmitted trigger frame, a feedback in one or more long training fields (LTFs) included in a response from at least one station of the set of stations.

2. The method of claim 1, wherein the response is a physical (PHY) layer protocol data unit (PPDU) without a data payload and the feedback is included in a PHY header of the PPDU.

3. The method of claim 1, wherein the feedback from the at least one station is a multi-bit feedback.

4. The method of claim 3, wherein the feedback from the at least one station includes at least one of a buffer status report (BSR), operating mode information (OMI), high efficiency (HE) Link Adaptation information, uplink power headroom information, bandwidth query report information, or channel state information.

5. The method of claim 1, wherein the set of stations includes a first station and a second station;
wherein the trigger frame includes a plurality of user information fields including a first user information field and a second user information field; and
wherein the first user information field indicates a first set of resources for the first station for providing a first feedback, and the second user information field indicates a second a second set of resources for the second station for providing a second feedback.

6. The method of claim 5, wherein first user information field further indicates a first association identifier (AID) identifying the first station and the second user information field further indicates a second AID identifying the second station.

7. The method of claim 1, wherein the trigger frame is included in a broadcast resource unit of a multi-user downlink (MU DL) PPDU, the MU DL PPDU further comprising downlink data for a second set of stations;
wherein the feedback is received from the at least one station in a first frequency band; and
wherein the method further comprises receiving, from at least one station of the second set of stations, an acknowledgement (ACK) for the downlink data in a second frequency band, the second frequency band being different than the first frequency band.

8. The method of claim 1, wherein the trigger frame further comprises a request for uplink data from a second set of stations;
wherein the feedback is received from the at least one station in a first frequency band; and
wherein the method further comprises receiving uplink data, in a second frequency band, from one or more stations of the second set of stations, the second frequency band being different than the first frequency band and including a higher frequency range than the first frequency band.

9. The method of claim 1, wherein the trigger frame is a beamforming report poll (BRP) trigger frame and the feedback from the at least one station includes at least channel state information, the method further comprising:
performing channel estimation based on the received feedback.

10. The method of claim 1, wherein the trigger frame further indicates a type of feedback requested by the access point.

11. The method of claim 1, wherein the trigger frame includes a common information field indicating an uplink duration, the uplink duration implicitly indicating that a null data packet (NDP) feedback is requested by the access point.

12. A wireless device for wireless communication, comprising:
means for transmitting, to a set of stations, a trigger frame comprising a request for feedback from each station of the set of stations and an indication of a plurality of resources for each station to provide the feedback; and
means for receiving, based on the transmitted trigger frame, a feedback in one or more long training fields (LTFs) included in a response from at least one station of the set of stations.

13. The wireless device of claim 12, wherein the response is a physical (PHY) layer protocol data unit (PPDU) without a data payload and the feedback is included in a PHY header of the PPDU.

14. The wireless device of claim 12, wherein the feedback from the at least one station is a multi-bit feedback.

15. The wireless device of claim 14, wherein the feedback from the at least one station includes at least one of a buffer status report (BSR), operating mode information (OMI), high efficiency (HE) Link Adaptation information, uplink power headroom information, bandwidth query report information, or channel state information.

16. The wireless device of claim 12, wherein the set of stations includes a first station and a second station;
wherein the trigger frame includes a plurality of user information fields including a first user information field and a second user information field; and
wherein the first user information field indicates a first set of resources for the first station for providing a first feedback, and the second user information field indicates a second a second set of resources for the second station for providing a second feedback.

17. The wireless device of claim 16, wherein first user information field further indicates a first association identifier (AID) identifying the first station and the second user information field further indicates a second AID identifying the second station.

18. The wireless device of claim 12, wherein the trigger frame is included in a broadcast resource unit of a multi-user downlink (MU DL) PPDU, and the MU DL PPDU further comprises downlink data for a second set of stations;
wherein the feedback is received from the at least one station in a first frequency band; and
wherein the means for receiving is further configured to receive, from at least one station of the second set of stations, an acknowledgement (ACK) for the downlink data in a second frequency band, the second frequency band being different than the first frequency band.

19. The wireless device of claim 12, wherein the trigger frame further comprises a request for uplink data from a second set of stations;
wherein the feedback is received from the at least one station in a first frequency band; and
wherein the means for receiving is further configured to receive uplink data in a second frequency band from one or more stations of the second set of stations, the second frequency band being different than the first frequency band and including a higher frequency range than the first frequency band.

20. The wireless device of claim 12, wherein the trigger frame is a beamforming report poll (BRP) trigger frame and the feedback from the at least one station includes at least channel state information, and
wherein the wireless device further comprises means for performing channel estimation based on the received feedback.

21. The wireless device of claim 12, wherein the trigger frame includes a common information field indicating an uplink duration, the uplink duration implicitly indicating that a null data packet (NDP) feedback is requested by the wireless device.

22. A wireless device for wireless communication, comprising:
a memory; and
at least one processor coupled to the memory, wherein the at least one processor is configured to:
transmit, to a set of stations, a trigger frame comprising a request for feedback from each station of the set of stations and an indication of a plurality of resources for each station to provide the feedback; and
receive, based on the transmitted trigger frame, a feedback in one or more long training fields (LTFs) included in a response from at least one station of the set of stations.

23. The wireless device of claim 22, wherein the response is a physical (PHY) layer protocol data unit (PPDU) without a data payload and the feedback is included in a PHY header of the PPDU.

24. The wireless device of claim 22, wherein the feedback from the at least one station includes at least one of a buffer status report (BSR), operating mode information (OMI), high efficiency (HE) Link Adaptation information, uplink power headroom information, bandwidth query report information, or channel state information.

25. The wireless device of claim 22, wherein the set of stations includes a first station and a second station;
wherein the trigger frame includes a plurality of user information fields including a first user information field and a second user information field; and
wherein the first user information field indicates a first set of resources for the first station for providing a first feedback, and the second user information field indicates a second a second set of resources for the second station for providing a second feedback.

26. The wireless device of claim 25, wherein first user information field further indicates a first association identifier (AID) identifying the first station and the second user information field further indicates a second AID identifying the second station.

27. The wireless device of claim 22, wherein the trigger frame is included in a broadcast resource unit of a multi-user downlink (MU DL) PPDU, and the MU DL PPDU further comprises downlink data for a second set of stations;
wherein the feedback is received from the at least one station in a first frequency band; and
wherein the at least one processor is further configured to receive, from at least one station of the second set of stations, an acknowledgement (ACK) for the downlink data in a second frequency band, the second frequency band being different than the first frequency band.

28. The wireless device of claim 22, wherein the trigger frame further comprises a request for uplink data from a second set of stations;
wherein the feedback is received from the at least one station in a first frequency band; and
wherein the at least one processor is further configured to receive uplink data, in a second frequency band, from one or more stations of the second set of stations, the second frequency band being different than the first frequency band and including a higher frequency range than the first frequency band.

29. The wireless device of claim 22, wherein the trigger frame is a beamforming report poll (BRP) trigger frame and the feedback from the at least one station includes at least channel state information, and
wherein the at least one processor is further configured to perform channel estimation based on the received feedback.

30. A computer-readable medium having computer-executable code stored thereon that, when executed, causes a wireless device to:
transmit, to a set of stations, a trigger frame comprising a request for feedback from each station of the set of stations and an indication of a plurality of resources for each station to provide the feedback; and
receive, based on the transmitted trigger frame, a feedback in one or more long training fields (LTFs) included in a response from at least one station of the set of stations.
